(19) United States
(12) Patent Application Publication
(10) Pub. No.: US 2006/0031816 A1
(43) Pub. Date: Feb. 9, 2006

(54) Control method for device capable of using macro describing operation procedure

(75) Inventor: Yoshinobu Umeda, Tokyo (JP)

Correspondence Address: ROSSI, KIMMS & McDOWELL LLP., P.O. BOX 826, ASHBURN, VA, 20146-0826, US

(73) Assignee: CANON KABUSHIKI KAISHA, Ohta-ku (JP)

(21) Appl. No.: 11/197,298

(22) Filed: Aug. 5, 2005

(30) Foreign Application Priority Data
Aug. 6, 2004 (JP) 2004-231242

(51) Int. Cl. G06F 9/44

(52) U.S. Cl. 717/106; 717/136; 717/113

(57) ABSTRACT

In first and second data processing devices each of which stores an operation procedure to be executed through an operation unit and generates a macro for reproducing the stored operation procedure, the following processes are executed so that the macro generated in the first data processing device can be executed in the second data processing device of which the processing procedure is different from that of the first data processing device so as to acquire the same result. That is, the processing procedures of the first and second data processing devices are compared with each other, the processing procedure recorded in the macro is changed based on the compared result so that the macro generated in the first data processing device can be executed in the second data processing device, and the changed macro is actually executed in the second data processing device.

### BACKGROUND OF THE INVENTION

1. Field of the Invention

The present invention relates to an apparatus which stores an operation procedure to be executed through an operation unit and executes a macro for repeating the stored operation procedure, and a control method which is applied to the relevant apparatus.

2. Related Background Art

Conventionally, an image forming device such as a copying machine or the like comprises the operation panel unit, whereby various print modes and print environments are set by using the key groups each consisting of the plural keys and the display unit provided on the operation panel unit.

Moreover, conventionally, the complicated setting and the frequently used setting are previously registered to the respective dedicated keys or the like as macros, and, in the later setting of the print mode and/or the print environment to the copying machine, the registered macro is executed as appropriate by depressing the relative dedicated key, whereby the desired setting is executed (for example, see Japanese Patent Application Laid-Open No. 2002-185662). Here, it should be noted that the macro (also called a macro function or a macro process script) is equivalent to the program which is created to be able to repeat the relevant operation procedure set by the user. More specifically, the macro is the program which is once registered and then can be called and executed.

Here, the operation procedure by the user is not directly set as the macro to the image processing unit of the copying machine, but is registered to the dedicated key. This is because it causes to execute the operation completely according to the procedure set by the user from the operation panel unit. In other words, it aims to make the program in the image processing unit of the copying machine common in both the case where the setting is executed by the user from the operation panel unit and the case where the setting is executed by the macro. Thus, it is possible to later add the macro by the dedicated key, without adding and verifying the program.

However, in case of transferring the above conventional macro to another copying machine, the following problems possibly occur. That is, if the screen constitutions or the settable functions on the screens are mutually different between the copying machine from which the macro is transmitted or transferred and the copying machine to which the macro is transmitted or transferred, it is impossible to execute the desired setting if the macro is executed by depressing the dedicated key.

Moreover, in recent years, since various functions and settings are added to the copying machine, it is impossible to display all the functions on the operation panel unit at a time. For this reason, the operation panel unit provides the plural display pages (screens) for divisionally displaying the functions, and the displayed plural pages (screens) are appropriately changed or shifted by depressing the predetermined button.

Besides, since the order of functions can be easily changed if the user modifies (or customizes) the contents of the operation panel, to which of the plural display pages the button for executing the arbitrary function belongs is different with respect to each copying machine. Thus, even in a case where the macro with the dedicated key is transmitted to and used by the copying machines of the same kind, it is impossible to execute the desired setting due to the modified operation panels of the copying machines.

### SUMMARY OF THE INVENTION

One feature of the present invention is to provide a data processing device which can eliminate the above conventional problems, and the control method thereof.

Another feature of the present invention is to provide data processing devices which can share a macro, and the control method thereof.

Still another feature of the present invention is to provide a data processing device which creates a macro capable of being used by many devices, and the control method thereof.

The above features and other features of the present invention will be apparent from the following description when taken in conjunction with the accompanying drawings, in which like reference characters designate the same or similar parts throughout the figures thereof.

### BRIEF DESCRIPTION OF THE DRAWINGS

FIG. 1 is a diagram showing the constitution of an image forming system according to the embodiment of the present invention;

FIG. 2 is a block diagram showing the constitution of an MFP (multi function peripheral);

FIG. 3 is a flow chart showing the procedure of a macro generation process;

FIG. 4 is a diagram showing the screen of an operation panel unit 1 in the initial state;

FIG. 5 is a diagram showing the application mode screen to be displayed when an application mode button 312 is depressed;

FIG. 6 is a diagram showing the original size selection screen to be displayed when a reduction layout button 403 shown in FIG. 5 is depressed;

FIG. 7 is a diagram showing the reduction layout kind selection screen for selecting a kind of reduction layout, to be displayed when a “next” button 502 shown in FIG. 6 is depressed;

FIG. 8 is a diagram showing the recording paper selection screen for selecting recording papers for the reduction layout, to be displayed when a “next” button 602 shown in FIG. 7 is depressed;

FIG. 9 is a diagram showing the screen to be displayed when an “OK” button 702 shown in FIG. 8 is depressed;

FIG. 10 is a diagram showing the operation mode screen to be displayed when the continuous reading is set;

FIG. 11 is a diagram showing the initial screen;

FIG. 12 is a diagram showing the screen of the operation panel unit 1 on which the button for executing the generated macro is displayed;

FIG. 13 is a diagram showing the macro which is generated on a buffer memory 10 by the CPU of a microprocessor unit 9 and stored in a storage device 4;

FIG. 14 is a flow chart showing the procedure of the process for changing the macro generated by the first MFP to be used in the second MFP and then transmitting the changed macro to the second MFP;

FIG. 15 is a diagram showing the operation screen on which a reduction layout button 403 is arranged;

FIG. 16 is a diagram showing the operation screen on which a continuous reading button 409 is arranged; and

FIG. 17 is a diagram showing the transmission macro to be transmitted to the second MFP.

### DETAILED DESCRIPTION OF THE PREFERRED EMBODIMENTS

Hereinafter, the embodiments of the present invention will be explained with reference to the attached drawings.

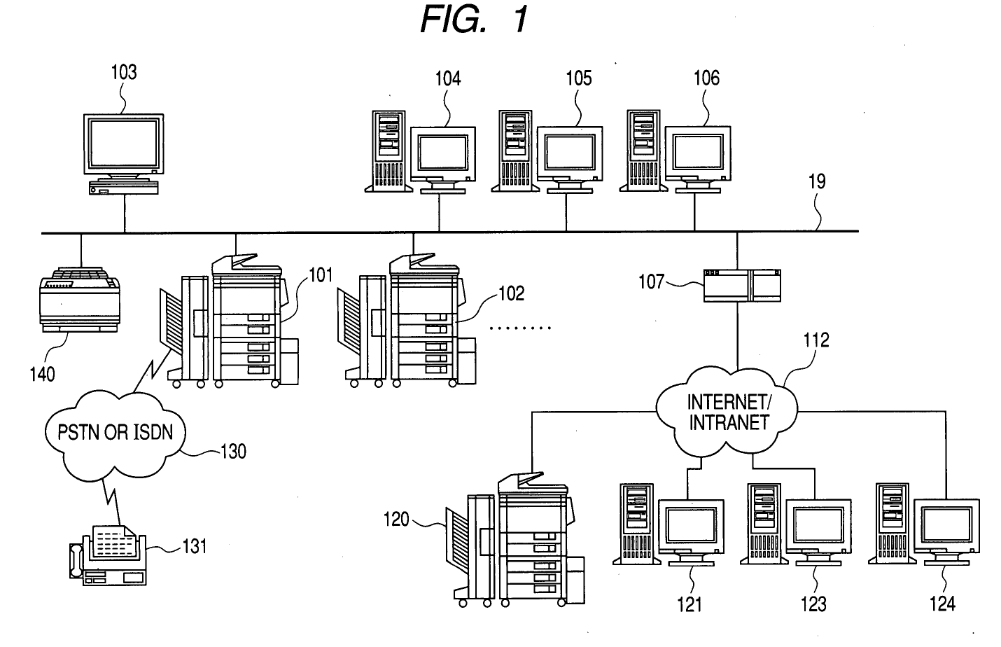

FIG. 1 is a diagram showing the constitution of an image forming system according to the embodiment of the present invention. In the image forming system of FIG. 1, a first MFP 101, a second MFP 102, a client PC (personal computer) 103, a database server 104, an electronic mail server 105, a WWW (World Wide Web) server 106 and a printer 140 are mutually connected through a LAN (local area network) 19. Further, a router 107 is connected to the LAN 19. Besides, an MFP 120, a database server 121, a WWW server 123, an electronic mail server 124 and the like are connected to an Internet/intranet 112 which is further connected to the LAN 19 through the router 107.

The first MFP 101, which comprises the scanner (reader) unit and the printer unit, outputs the image data read by the scanner unit to the LAN 10, and causer the printer unit to print the image data received from the scanner unit or the LAN 19. Further, the first MFP 101 can transmit/receive the data to/from a FAX (facsimile) device 131 through a PSTN (Public Switched Telephone Network) or ISDN (Integrated Services Digital Network) 130. Thus, the image data read from the scanner unit of the first MFP 101 is transmitted from a FAX transmission unit (not shown) to the PSTN or ISDN 130, and the image data received from the PSTN or ISDN 130 is printed by the printer unit.

The second MFP 102 is the MFP which has the capacity equivalent to that of the first MFP 101, and, as well as the first MFP 101, the second MFP 102 is connected to the LAN 10. Incidentally, although FIG. 1 shows only the first MFP 101 and the second MFP 102, it is of course possible to connect another MFP to the LAN 19.

The database server 104 manages, as the database, the image data read from the scanner unit of each of the first MFP 101 and the second MFP 102. The electronic mail server 105 can receive, as the attached file of the electronic mail, the image data read from each of the first MFP 101 and the second MFP 102.

The WWW server 106 provides an HTML (Hyper Text Markup Language) document to the LAN 19. Thus, the HTML document provided from the WWW server 106 can be printed by each of the first MFP 101 and the second MFP 102.

The client PC 103 is used by a user to browse and search the image data stored in the database server 104, to receive and browse the mail received by the electronic mail server 105, and to transmit an electronic mail. Moreover, the client PC 103 indicates to print the image data in the database server 104, the electronic mail server 105 and the WWW server 106 and the data in the client PC 103 itself, by using the first MFP 101 and the second MFP 102. Incidentally, although FIG. 1 shows only one client PC 103, it is of course possible to connect plural client PC's to the LAN 19.

The router 107 is used to link the LAN 19 and the Internet/intranet 112 to each other. As described above, the MFP 120, the database server 121, the WWW server 123 and the electronic mail server 124 which constitute the device group equivalent to the device group including the first MFP 101, the database server 104, the WWW server 106 and the electronic mail server 105 are connected to the Internet/intranet 112. Moreover, the printer 140 is connected to the LAN 19, whereby the image data read by the first MFP 101 and the second MFP 102 can be printed by the printer 140.

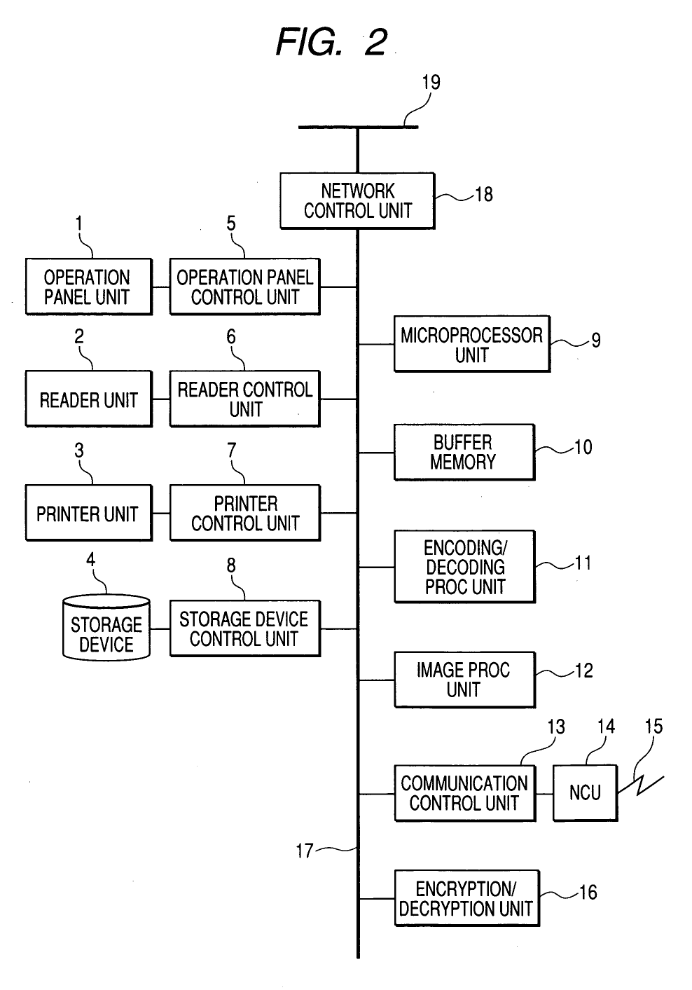

FIG. 2 is a block diagram showing the constitution of the first MFP 101. Incidentally, it should be noted that, as described above, the constitution of the second MFP 102 is the same as that of the first MFP 101. Here, a microprocessor unit 9, a buffer memory 10, an encoding/decoding processing unit 11, an image processing unit 12, a communication control unit 13, an encryption/decryption unit 16, an operation panel control unit 5, a reader control unit 6, a printer control unit 7, a storage device control unit 8 and a network control unit 18 are mutually connected through an internal bus 17 in the first MFP 101. Further, a reader unit 2 is connected to the reader control unit 6, a printer unit 3 is connected to the printer control unit 7, and a storage device 4 is connected to the storage device control unit 8. Furthermore, the network control unit 18 is connected to the LAN 19, and an NCU (network control unit) 14 for controlling a telephone line 15 is connected to the communication control unit 13.

The dials, the switches and the like which are handled and operated by the user are arranged on the operation panel unit 1. Thus, the indications of the operations such as copying, facsimile transmission and the like, the settings of enlargement/reduction magnifications, the setting for inputting the telephone number of the communication destination, and the like are executed by using the operation panel unit 1. The reader unit (or reading unit) 2 optically scans the original to be transmitted, and generates an image signal (or image data) based on the scanned original. In other words, the original is first put on the original mounting board of the reader unit 2, and the photoelectric transformation elements such as CCD's or the like aligned in the main scan direction are moved toward the direction perpendicular to the element-aligned direction (that is, the sub scan direction) so as to read the original, whereby the electrical image data is generated. Then, the image data read by the reader unit 2 is stored in the buffer memory 10 through the reader control unit 6.

The printer unit 3, which adopts an electrophotographic system, records the image data read by the reader unit 2 and the reception signal transmitted through the telephone line 15 on a recording paper. Incidentally, the image data stored in the buffer memory 10 is output and transferred to the printer unit 3 through the printer control unit 7.

The storage device 4, which is the nonvolatile memory such as a hard disk or the like, stores the image data read by the reader unit 2 and the reception signal transmitted through the telephone line 15. As described later in detail, the image data or the reception signal is stored in the storage device 4 through the buffer memory 10, and the image data or the reception signal stored in the storage device 4 is read also through the buffer memory 10.

The operation panel control unit 5 controls the operation panel unit 1. More specifically, the operation panel control unit 5 analyzes the indication by the user input through the operation panel unit 1, and transfers the analyzed indication to the microprocessor unit 9. The reader control unit 6 controls the reader unit 2. More specifically, the reader control unit 6 drives the reader unit 2 based on the indication by the microprocessor unit 9 to read the original put on the original mounting board, and then stores the read image data in the buffer memory 10.

The printer control unit 7 controls the printer unit 3. More specifically, the printer control unit 7 acquires the image data or the reception signal from the buffer memory 10 in response to the indication issued from the microprocessor unit 9, outputs the acquired data or the acquired signal to the printer unit 3, and drives in synchronism with the output of the image data the printer unit 3 to print the image on the recording paper. The storage device control unit 8 controls the storage device 4. More specifically, the storage device control unit 8 transfers the data from the buffer memory 10 to the storage device 4 and further outputs the data from the storage device 4 to the buffer memory 10, in response to the indication issued from the microprocessor unit 9.

The microprocessor unit 9 controls the whole operation of the MFP. More specifically, the MFP achieves the various operations such as scanning, printing, facsimile transmission, facsimile reception and the like in response to the respective indications issued from the microprocessor unit 9. Moreover, the microprocessor unit 9 contains the known CPU, the ROM which stores the later-described programs and the like, the RAM which temporarily stores the data necessary for the control, and the like.

When the original is read from the reader unit 2, when the image data is read from the storage device 4, when the data is acquired through the facsimile reception and the network, or the like, the relevant image data or the relevant reception signal is once stored in the buffer memory 10. Moreover, when the image data is printed by the printer unit 3, when the image data stored in the storage device 4, or when the data is output through the facsimile transmission or the network, the relevant image data or the relevant transmission signal is output from the buffer memory 10.

The encoding/decoding processing unit 11 executes the encoding (compression process) to the image data or the transmission signal stored in the buffer memory 10, if necessary. Moreover, the encoding/decoding processing unit 11 executes the decoding (extraction process) to the compressed image data or the reception signal, if necessary.

The image processing unit 12 executes the image process, the image quality improvement process and the like which are indicated by the user through the operation panel unit 1. Moreover, when the facsimile transmission is executed, the image processing unit 12 transforms the resolution, the paper size and the like of the image data to be transmitted, in conformity with the capacity of the transmission destination (communication partner).

The communication control unit 13 controls the communication to be executed between the MFP and other communication devices connected to the telephone line 15. That is, the facsimile transmission and the facsimile reception are executed through the communication control unit 13. The NCU 14 executes the connection control so that the telephone line 15 is used in the data communication or the like. Besides, the encryption/decryption unit 16 encrypts the image data, and decrypts the encrypted image data.

The interval bus 17 is used to mutually connect the respective functional blocks in the MFP. Here, it should be noted that, through the internal bus 17, the image data are transferred, and the commands and the setting values to be used to operate the respective functional blocks are transmitted and received.

The network control unit 18 is used to connect the internal bus 17 to the external LAN 19. The network control unit 18 executes the protocol transformation between the external LAN 19 and the internal bus 17. More specifically, by the network control unit 18, the image data input through the external LAN 19 is stored in the buffer memory 10, printed by the printer unit 3, or stored in the storage device 4, as well as the image data read from the reader unit 2.

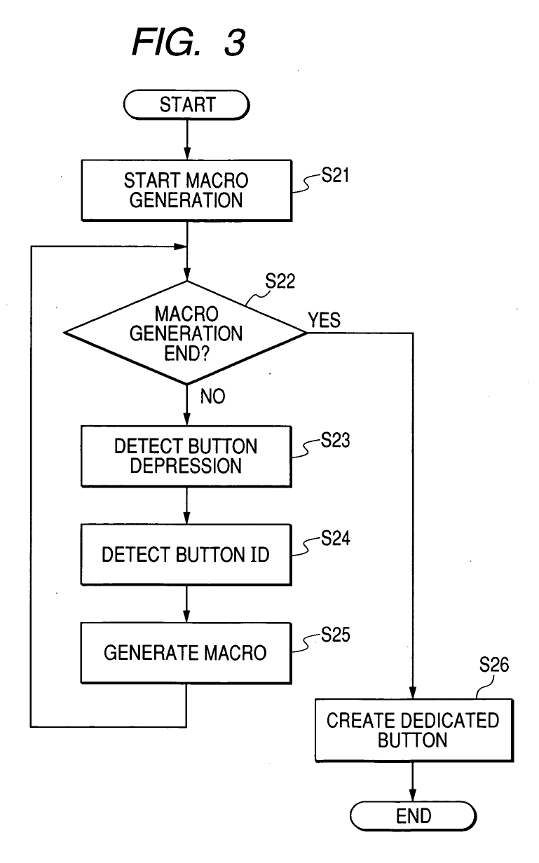

Subsequently, the operation of the image forming device having the above-described constitution will be explained. FIG. 3 is a flow chart showing the procedure of the macro generation process. Here, it should be noted that the relevant processing program is stored in the ROM of the microprocessor unit 9, and executed by the CPU. In the macro (also called the macro function or the macro process script) generation process, a series of the settings by the user is allocated to the dedicated button. Incidentally, although the description system of the macro to be generated here is not especially limited, it is desirable to use a general-purpose system such as a plain text system or the like, because a file of this type is applicable to the devices of various types, and the program for generating and interpreting the macro can be simplified.

Initially, if it is detected that the predetermined button disposed on the operation panel 1 is depressed by the user, the CPU of the microprocessor unit 9 starts the mode of generating the macro (step S21). Then, it is judged whether or not the predetermined button for ending the generation of the macro is depressed (step S22). After then, every time the button on the operation panel unit 1 is depressed by the user, it is detected from the operation panel control unit 5 that the predetermined button is depressed (step S23). At that time, the operation panel control unit 5 detects which of the plural buttons disposed on the same screen is depressed, on the basis of the depressed location on the operation panel unit 1. Thus, the CPU of the microprocessor unit 9 acquires the value (button ID) indicating the kind of depressed button and transferred from the operation panel control unit 5 (step S24). Moreover, the program (macro) which indicates the operation procedure for depressing the button indicated by the button ID is generated (step S25), and the flow returns to the step S22. Then, by repeating the processes in the steps S22 to S25, the macro for executing the series of operations is generated in the microprocessor unit 9.

Incidentally, when it is judged in the step S22 that the predetermined button on the operation panel unit 1 for ending the generation of the macro is depressed by the user and it is detected by the CPU of the microprocessor unit 9 that the macro generation mode ends, the dedicated button for executing the macro generated up to then is created or generated on the operation panel unit 1 (step S26), and the macro generation process ends.

More specifically, the operation for generating the macro dedicated button according to the flow chart shown in FIG. 3 will be explained hereinafter. Here, the macro for executing the “2 in 1” operation and the “continuous reading” operation is generated, and it is assumed that the macro generation mode in the step S21 has been set by depressing the “macro generation start” button.

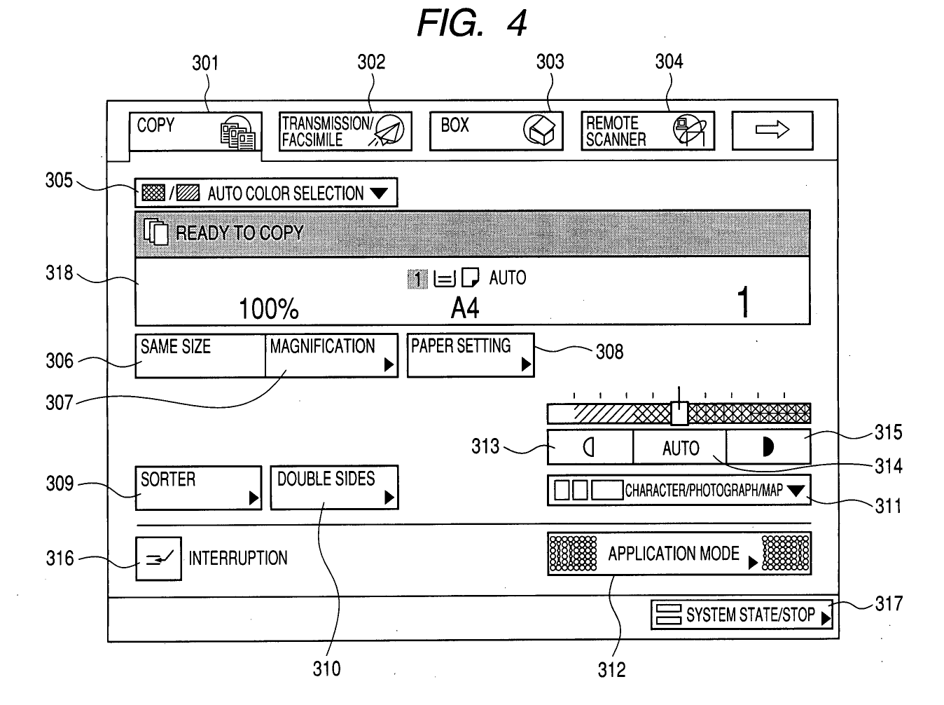

FIG. 4 is a diagram showing the screen of the operation panel unit 1 in the initial state. More specifically, a copy button 301, a transmission/facsimile button 302, a box button 303 and a remote scanner button 304 are arranged at the upper part of the operation panel unit 1. The copy button 301 is the button for displaying the operation screen to be used to execute the copy operation, and the transmission/facsimile button 302 is the button for displaying the operation screen to be used to output, through the LAN 19 or the telephone line 15, the image data read from the reader unit 2 and the image data stored in the storage device 4. The box button 303 is the button for displaying the operation screen to be used to store in the storage device 4 the image data read from the reader unit 2, and the remote scanner button 304 is the button for displaying the operation screen to be used to execute the remote scanning for reading the image by using an external reading device. Incidentally, in FIG. 4, since the copy button 301 is selected, the operation screen to be used to execute the copy operation is displayed on a screen 318 of the operation panel unit 1.

Besides, an image kind selection button 305, a same size button 306, a magnification button 307, a paper selection button 308, a sorter button 309, a double-sided reading/copying button 310, a mode selection button 311, an application mode button 312, density setting buttons 313, 314 and 315, an interruption button 316, a system state/stop button 317, and the like are arranged on the operation panel unit 1.

The image kind selection button 305 is the button for selecting the kind of image to be read from the reader unit 2. More specifically, it is possible by the image kind selection button 305 to set the color original reading, the black-and-white original reading, the automatic discrimination reading and the like. The same size button 306 is the button for setting the magnification to 100%, the magnification button 307 is the button for displaying the screen to be used to set predetermined enlargement and reduction ratios, the paper selection button 308 is the button for displaying the screen to be used to select the paper for the printing by the printer unit 3, and the sorter button 309 is the button for displaying the screen to be used to execute the output setting in case of the printing of the plural copies. The double-sided reading/copying button 310 is the button for displaying the screen to be used to set whether to execute the double-sided reading or the single-sided reading of the originals in case of reading the image from the reading unit 2, and to be used to set whether to execute the double-sided printing or the single-sided printing on the recording paper in case of printing the image by the printer unit 3.

The mode selection button 311 is the button for selecting the mode of reading the original image by the reader unit 2. More specifically, the mode selecting button 311 is depressed to select any one of the character mode, the photograph mode, the character/photograph mixture mode, the map mode, and the like. The application mode button 312 is the button for displaying the screen of the application mode which is used in case of executing the various functions and the various settings in the copy operation. The density setting buttons 313, 314 and 315 are the buttons for setting the densities of the printing on the recording paper by the printer unit 3. More specifically, the density is set to be low by depressing the density setting button 313, the density is set to be high by depressing the density setting button 315, and the density is returned to the initial value by depressing the density setting button 314. The interruption button 316 is the button for once stopping the operation of the currently operating MFP and instead executing preferentially the newly set operation, and the system state/stop button 317 is the button for displaying the screen showing the current state of the MFP and the screen to be used to stop the currently operating job.

Incidentally, it should be noted that the inherent value (button ID) is allocated to each of all the buttons arranged on the operation panel unit 1. Thus, the operation panel control unit 5 detects which of the plural buttons is depressed, on the basis of the depressed location on the operation panel unit 1, and then transfers the button ID corresponding to the depressed button to the microprocessor unit 9. Then, the microprocessor unit 9 acquires the button ID transferred from the operation panel control unit 5, and thus executes the process corresponding to the acquired button ID. Here, in the present embodiment, to simplify the explanation, the numerals shown in FIG. 4 which denote the respective buttons are set to be the same as the corresponding button ID. That is, each of the numerals 301 to 317 in FIG. 4 which denotes the corresponding button also indicates the button ID corresponding to the relevant button. However, it is of course apparent that the button ID's are not relative to the numerals in the drawing, whereby it is possible to arbitrarily determine the button ID's. For example, it is possible to determine and set the button ID's as “ab11”, “ab12”, “ab13”, . . . which correspond to the buttons 301, 302, 303, . . . , respectively. Moreover, in the present embodiment, when the application mode button 312 is depressed, the screen for setting the application mode is displayed.

Here, if it is judged by the operation panel control unit 5 in the step S23 that the application mode button 312 is depressed, then the button ID corresponding to the application mode button 312 is detected and transferred to the microprocessor unit 9 in the step S24. Then, in the step S25, the CPU of the microprocessor unit 9 acquires the relevant button ID transferred from the operation panel control unit 5, and thus generates in the buffer memory 10 the macro “the button ID 312 is depressed”.

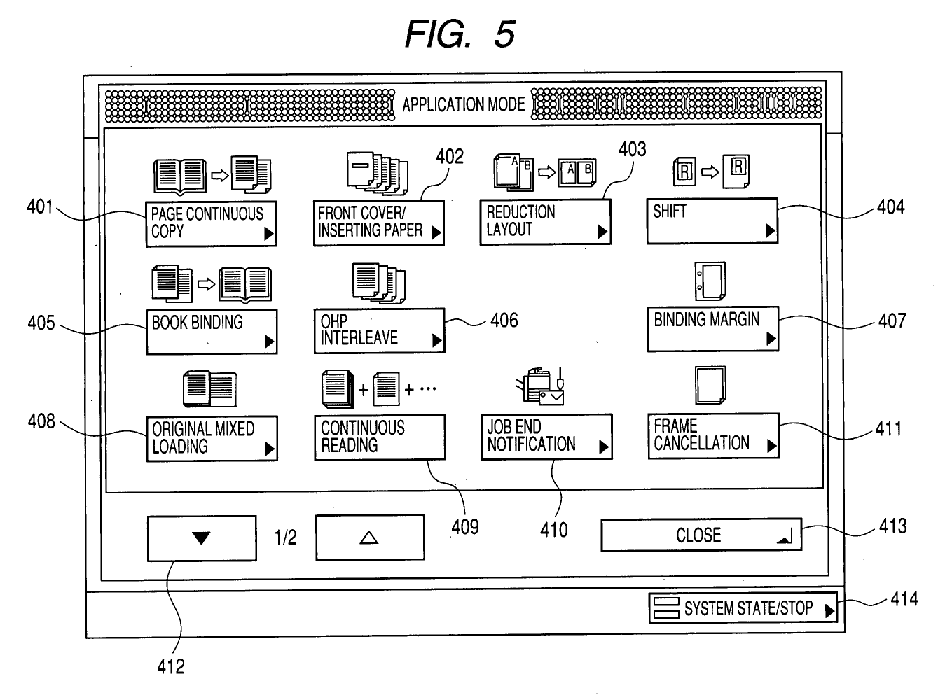

FIG. 5 is a diagram showing the application mode screen to be displayed when the application mode button 312 is depressed. Here, a page continuous copy button 401, a front cover/inserting paper button 402, a reduction layout button 403, a shift button 404, a book binding button 405, an OHP (overhead projector) button 406, a binding margin button 407, an original mixed loading button 408, a continuous reading button 409, a job end notification button 410, a frame cancellation button 411, a next page button 412, a close button 413, and a system state/stop button 414 are arranged on the application mode screen.

More specifically, the page continuous copy button 401 is the button for displaying the screen to be used, when the opened-book original (that is, the original of the opened-book state) is read from the reader unit 2, to set whether to read the left-opened book (for example, English paperback) or the right-opened book (for example, Japanese mass market paperback). The front cover/inserting paper button 402 is the button for displaying the screen to be used to execute the setting for adding a font cover, a back cover or the like. The reduction layout button 403 is the button for displaying the screen to be used to execute the setting of the reduction layout recording. Here, it should be noted that, in the reduction layout recording, the “N in 1” (“2 in 1”, “4 in 1”, “8 in 1”, etc.) reduction layout recording is executed, whereby the N original images are first reduced and then the reduced N images are recorded on the single recording paper. Further, the shift button 404 is the button for displaying the screen to be used to set the print location on the recording paper.

Furthermore, the book binding button 405 is the button for displaying the screen to be used to execute the setting so that the printed results acquired by the printer unit 3 become the state of book. The OHP button 406 is the button for displaying the screen to be used, in case of the printing for the OHP, to execute the setting concerning the means for supplying film papers to the OHP, and to further execute the setting as to whether the content same as that displayed by the OHP should be printed on an interleave. The binding margin button 407 is the button for displaying the screen to be used to set the binding margin, and the original mixed loading button 408 is the button for displaying the screen to be used to, in case of reading the plural different-sized originals from the reader unit 2, execute the various settings to cope with such reading.

Moreover, the continuous reading button 409 is the button for executing the setting so that the originals read from the reader unit 2 plural times are printed as a series of originals, and the job end notification button 410 is the button for displaying the screen to be used to execute the setting for notifying the user of the job end through an electronic mail and to set the address of the notification destination. The frame cancellation button 411 is the button for displaying the screen to be used to execute the setting for erasing the punch holes on the original by masking the peripheral parts of the relevant original, and to execute the setting for erasing the frames of the book original.

The next page button 412 is the button for displaying the next page of the screen in the application mode. That is, when the next page button 412 is depressed, the screen corresponding to the next page in the application mode is displayed on the operation panel unit 1. Further, the close button 413 is the button for ending the setting in the application mode and thus returning the screen to that shown in FIG. 4. Furthermore, the system state/stop button 414 is the button for displaying, as well as the system state/stop button 317, the screen showing the current state of the MFP and the screen to be used to stop the currently operating job.

Incidentally, as well as FIG. 4, it should be noted that the inherent button ID is allocated to each of all the buttons arranged on the application mode screen shown in FIG. 5. Thus, when the button on the operation panel unit 1 is depressed, the operation panel control unit 5 detects which of the plural buttons is depressed, on the basis of the depressed location on the operation panel unit 1, and then transfers the button ID corresponding to the depressed button to the microprocessor unit 9. Moreover, as well as FIG. 4, each of the numerals 401 to 414 shown in FIG. 5 which denotes the corresponding button also indicates the button ID corresponding to the relevant button.

Hereinafter, an example of setting the “2 in 1” operation and the “continuous reading” operation will be explained. First, to set the “2 in 1” operation, the reduction layout button 403 is depressed to display the setting screen of the reduction layout. That is, if the operation panel control unit 5 detects in the step S23 that the reduction layout button 403 is depressed, the operation panel control unit 5 further detects the button ID “403” corresponding to the reduction layout button 403 in the step S24. Then, the operation panel control unit 5 transfers the detected button ID “403” to the microprocessor unit 9. In the step S25, the CPU of the microprocessor unit 9 acquires the button ID transferred from the operation panel control unit 5, and generates in the buffer memory 10 the macro “the button ID 403 is depressed”.

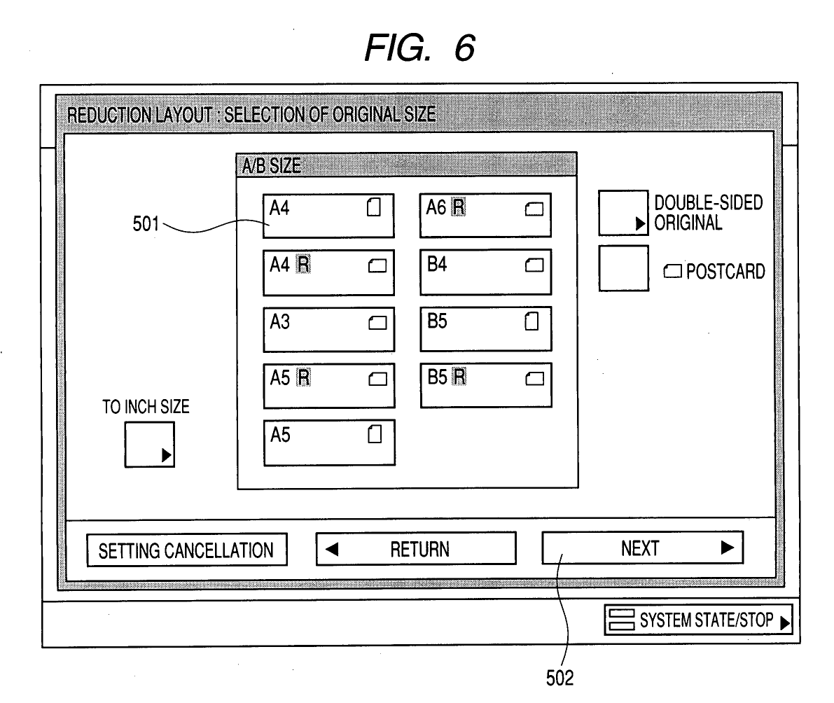

FIG. 6 is a diagram showing the original size selection screen to be displayed when the reduction layout button 403 shown in FIG. 5 is depressed. Here, an A4 button 501, a “next” button 502 and other various buttons are arranged on the original size selection screen. Incidentally, as well as FIGS. 4 and 5, it should be noted that the inherent button ID is allocated to each of all the buttons arranged on the original size selection screen shown in FIG. 6.

In FIG. 6, in case of determining the size of the original to be read in the reader unit 2, the A4 button 501 (button ID “501”) is depressed and then the “next” button 502 (button ID “502”) is depressed, whereby it is possible to execute the next setting. That is, in FIG. 6, the processes in the steps S23 to S25 are executed twice, and the CPU of the microprocessor unit 9 generates in the buffer memory 10 the macro “the button ID 501 is depressed” and “the button ID 502 is depressed”.

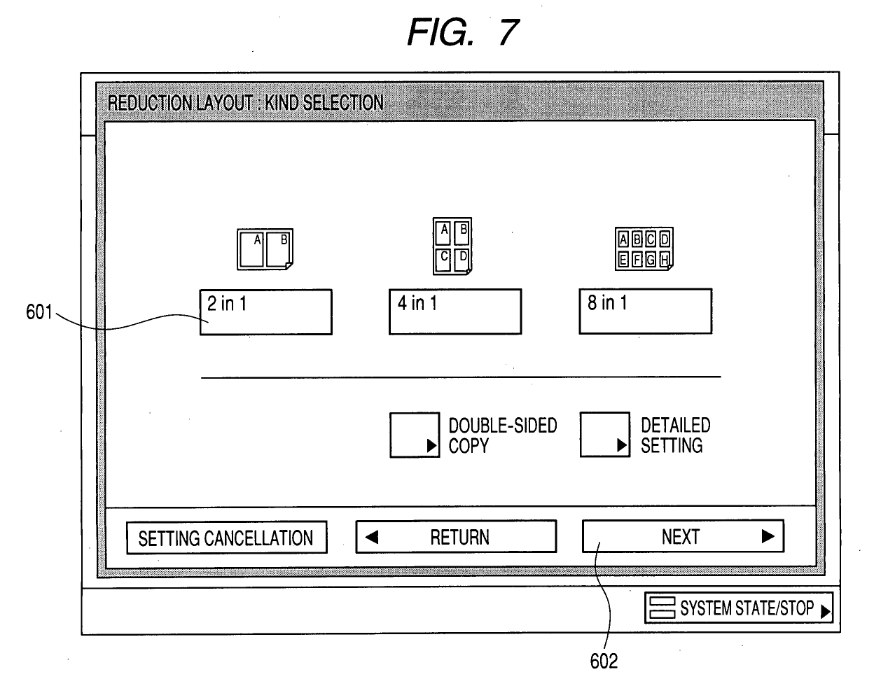

FIG. 7 is a diagram showing the reduction layout kind selection screen for selecting the kind of reduction layout, to be displayed when the “next” button 502 shown in FIG. 6 is depressed. Here, a “2 in 1” mode button 601, a “next” button 602 and other various buttons are arranged on the reduction layout kind selection screen. Incidentally, as well as FIGS. 4, 5 and 6, it should be noted that the inherent button ID is allocated to each of all the buttons arranged on the reduction layout kind selection screen shown in FIG. 7.

On the screen shown in FIG. 7, the number of recording papers to be used to print the original read by the reader unit 2 is designated. That is, in the present embodiment, the two-page print (“2 in 1” mode) is designated by depressing the “2 in 1” mode button 601 (button ID “601”), and the next setting is executed after depressing the “next” button 602 (button ID “602”). That is, as well as FIG. 6, the processes in the steps S23 to S25 are executed twice in FIG. 7, and the CPU of the microprocessor unit 9 generates in the buffer memory 10 the macro “the button ID 601 is depressed” and “the button ID 602 is depressed”.

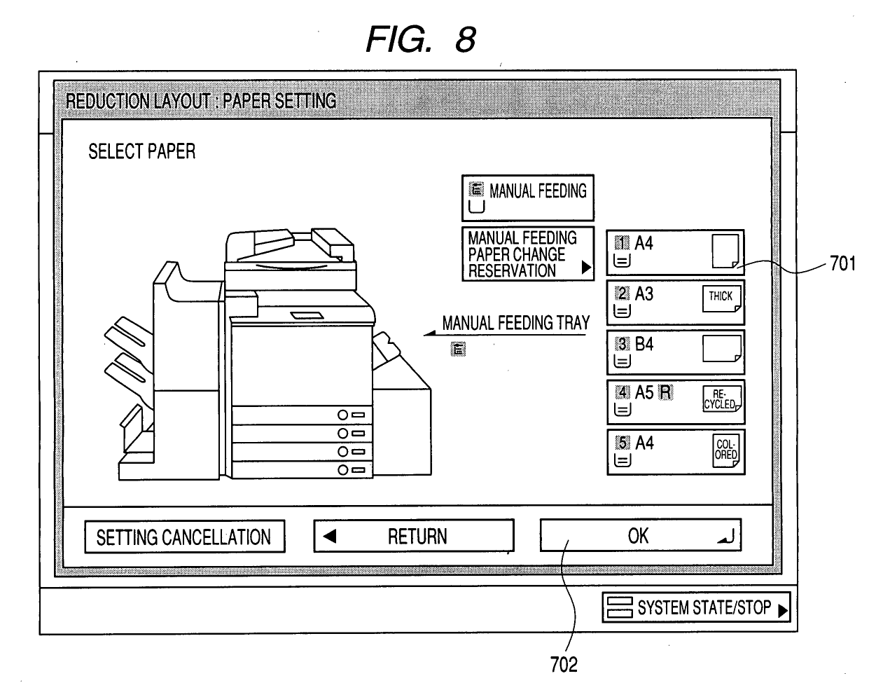

FIG. 8 is a diagram showing the recording paper selection screen for selecting the recording papers for the reduction layout, to be displayed when the “next” button 602 shown in FIG. 7 is depressed. Here, an A4 button 701, an “OK” button 702 and other various buttons are arranged on the recording paper selection screen. Incidentally, as well as FIGS. 4, 5, 6 and 7, it should be noted that the inherent button ID is allocated to each of all the buttons arranged on the recording paper selection screen shown in FIG. 8.

In FIG. 8, the A4 button 701 (button ID “701”) is depressed as the size of the recording paper to which the printing is executed by the printer unit 3, and then the “OK” button 702 (button ID “702”) is depressed, whereby the setting of the reduction layout ends. That is, as well as FIGS. 6 and 7, the processes in the steps S23 to S25 are executed twice in FIG. 8, and the CPU of the microprocessor unit 9 generates in the buffer memory 10 the macro “the button ID 701 is depressed” and “the button ID 702 is depressed”.

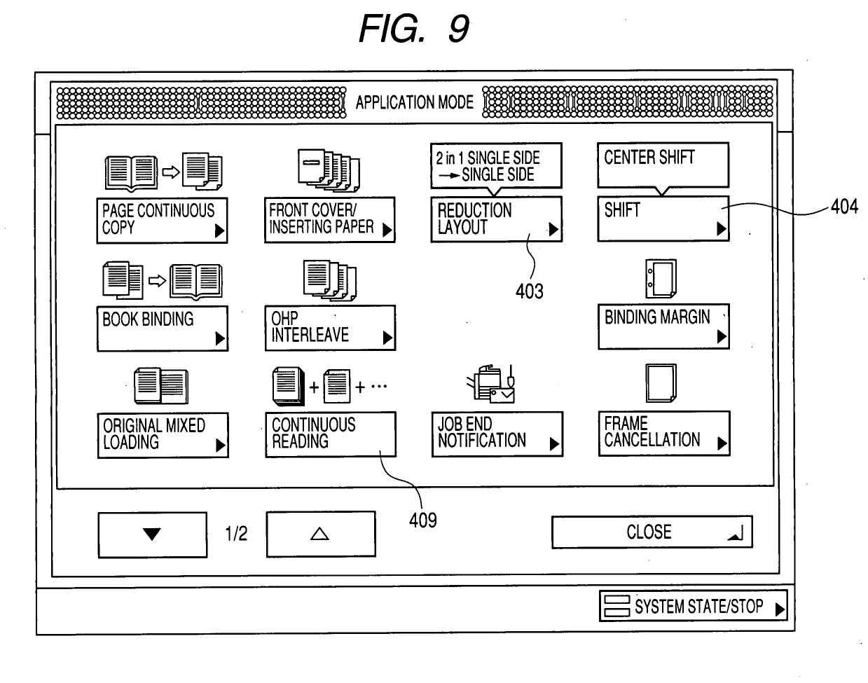

FIG. 9 is a diagram showing the screen to be displayed when the “OK” button 702 shown in FIG. 8 is depressed. Here, it should be noted that the screen shown in FIG. 9 is the application mode screen which is returned after all the settings for the reduction layout ended, and displays, by the settings in FIGS. 5 to 8, that the reduction layout setting of “2 in 1” and the setting of “center shift” have been executed. In other words, the colors of the reduction layout button 403 (button ID “403”) and the shift button 404 (button ID “404”) are changed, and the relevant setting contents are respectively displayed above these buttons. Incidentally, although the setting of “center shift” is not executed in the above explanation, it is set that the MFP in the present embodiment automatically executes the setting of “center shift” actually if the reduction layout is executed.

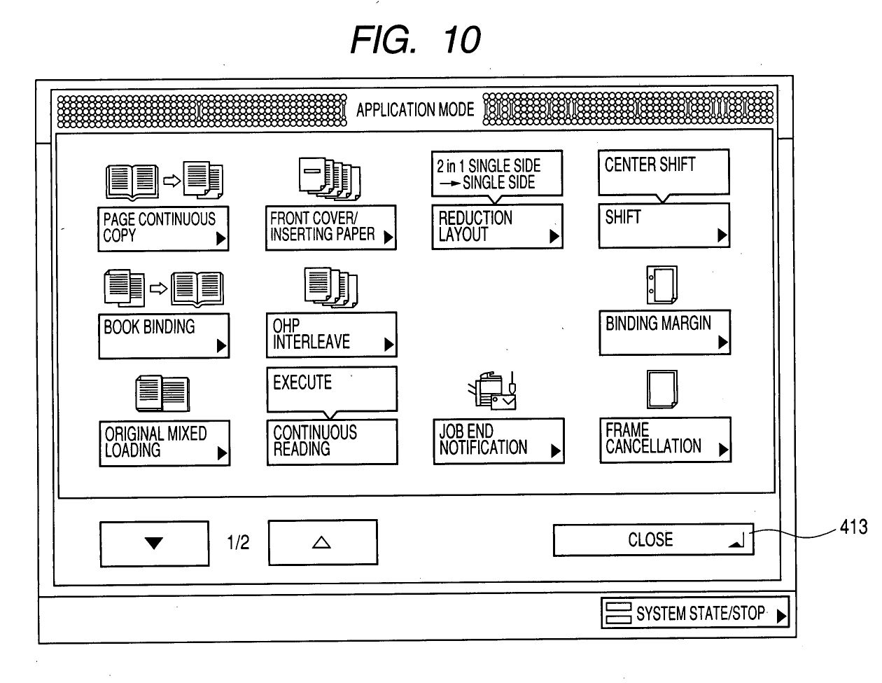

In any case, since the setting of “2 in 1” ends as above, the setting of “continuous reading” is then executed. More specifically, the setting of “continuous reading” is executed by depressing the continuous reading button 409 shown in FIG. 9. Incidentally, since it is unnecessary to execute the detailed setting in the setting of “continuous reading”, the setting itself ends by only depressing the continuous reading button 409. FIG. 10 is a diagram showing the operation mode screen, to be displayed when the continuous reading is set, on which the color of the continuous reading button 409 is changed and the setting content is displayed above this button.

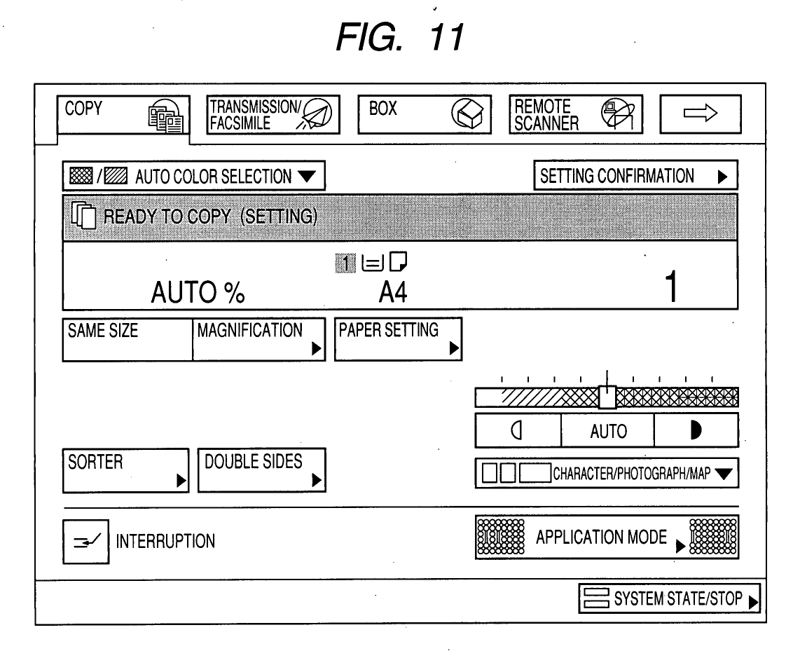

The CPU of the microprocessor unit 9 acquires the button ID transferred from the operation panel control unit 5, and generates the macro “the button ID 409 is depressed” in the buffer memory 10. In FIG. 10, since the settings of “2 in 1” and “continuous reading” have ended, the setting screen of the application mode is closed by depressing the close button 413, whereby the screen returns to the initial screen. Here, FIG. 11 is a diagram showing the initial screen. Also, at that time, if the operation panel control unit 5 detects in the step S23 that the relevant button is depressed, the operation panel control unit 5 further detects the button ID “413” corresponding to the close button 413 in the step S24. Then, in the step S25, the CPU of the microprocessor unit 9 generates the macro “the button ID 413 is depressed” in the buffer memory 10.

After the desired setting ended, for example, a “macro generation end” button is depressed to end the macro generation mode in the step S22. If the macro generation ends, in the step S26, the CPU of the microprocessor unit 9 transfers the macro generated in the buffer memory 10 to the storage device 4 and stores it therein. In addition, the CPU creates or generates the dedicated button for executing the stored macro, and thus displays the created button on the operation panel unit 1.

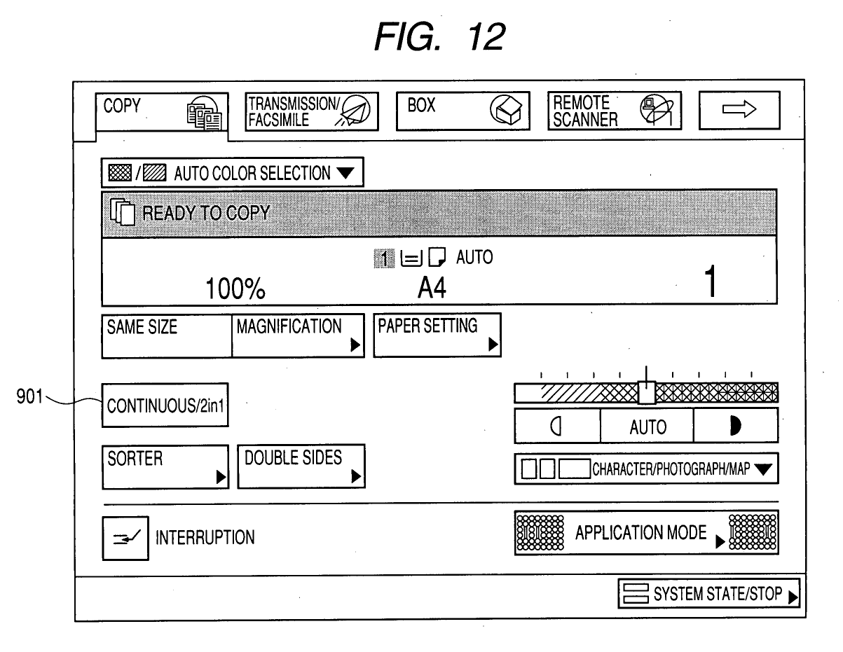

FIG. 12 is a diagram showing the screen of the operation panel unit 1 on which the button for executing the generated macro is displayed. More specifically, a newly created or generated “continuous/2 in 1” button 901 is arranged on this screen. Incidentally, it should be noted that the name of this button can of course be arbitrarily set by the user, and also a new inherent button ID (e.g., “901”) is allocated to the “continuous/2 in 1” button 901.

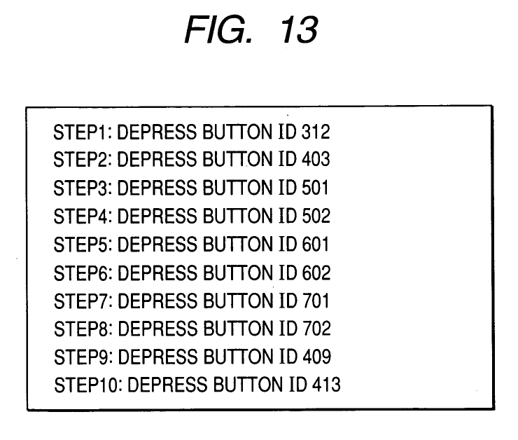

FIG. 13 is a diagram showing the macro which is generated on the buffer memory 10 by the CPU of the microprocessor unit 9 and stored in the storage device 4. That is, the macro indicated by STEP1 to STEP10 is stored in the storage device 4.

More specifically, if the “continuous/2 in 1” button 901, on the screen of the operation panel unit 1 shown in FIG. 12 is depressed by the user, the operation panel control unit 5 detects that the relevant portion on the screen of the operation panel unit 1 is depressed. Further, the operation panel control unit 5 detects the button ID based on the depressed location on the screen. Incidentally, if the operation panel control unit 5 detects the button ID “901” and transfers it to the microprocessor unit 9, the CPU of the microprocessor unit 9 detects that the depressed button is the button for executing the macro, calls and set the corresponding macro from the storage device 4, and then executes the set macro in due order.

As above, by the user's depression of the “continuous/2 in 1” button 901, the CPU of the microprocessor unit 9 executes the operation which is the same as that to be executed when the ten kinds of buttons are sequentially depressed in the order set by the macro, as indicated by STEP1 to STEP10 shown in FIG. 13. In other words, when the “continuous/2 in 1” button 901 is depressed, the operation which is the same as that to be executed when the respective buttons shown by STEP1 to STEP10 of FIG. 13 are sequentially depressed by the user is executed by the CPU of the microprocessor unit 9.

Subsequently, the macro transmission process will be explained hereinafter.

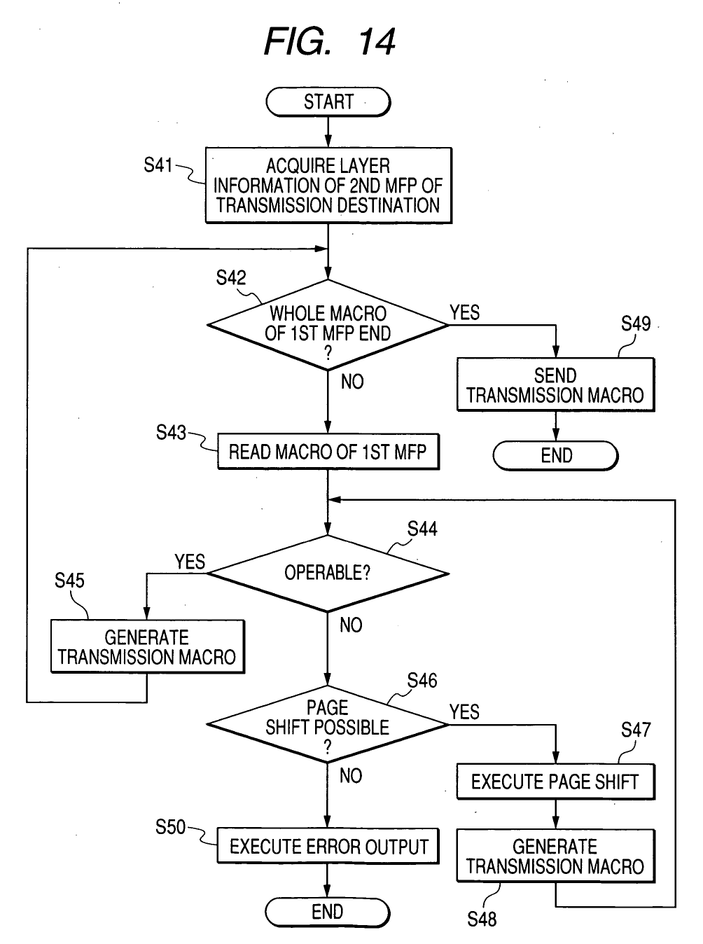

FIG. 14 is a flow chart showing the procedure of the process for changing the macro generated by the first MFP to be used in the second MFP and then transmitting the changed macro to the second MFP. Incidentally, the program for the relevant process is stored in the ROM of the microprocessor unit 9 and thus read and executed by the CPU of the microprocessor unit 9.

Here, the macro generated in the present embodiment is constituted so that the button ID's of the respective buttons to be depressed are described in due order. For this reason, for example, if the operation unit of the MFP at the transmission destination side has been modified (or customized) and thus the predetermined button has been moved or shifted to the screen different from that of the MFP at the transmission source side, there is a fear that the macro does not correctly operate. Consequently, according to the present embodiment, in case of transmitting the macro from the MFP at the transmission source to the MFP at the transmission destination, the relevant macro is previously modified (or processed) and then transmitted from the MFP at the transmission source so that the transmitted macro can be executed by the MFP at the transmission destination.

More specifically, initially, the first MFP 101 acquires from the second MFP 102 the layer information of the operation screen to be displayed on the operation panel unit of the second MFP 102 (step S41). Here, it should be noted that the layer information includes the information concerning the processes capable of being set or executed on the respective operation screens of the second MFP, the information concerning the arrangements of the buttons necessary to these processes, the information concerning the change order of the operation screens to be displayed after the respective processes ended, and the like.

Then, it is judged whether or not the macro by the first MFP ends (step S42). At first, since the macro does not end, the first operation of the macro (e.g., the operation of STEP1 shown in FIG. 13) transmitted from the first MFP is read (step S43). Then, it is judged by referring to the layer information acquired from the second MFP in the step S41 whether or not to be able to execute the first operation on the current operation screen (that is, the screen of the operation panel unit) of the second MFP (step S44).

If it is judged in the step S44 to be able to execute the first operation, the first operation of the macro acquired in the step S43 is generated as the transmission macro (that is, the macro to be transmitted) (step S45). At that time, the operation screen to be referred in the second MFP is changed to the operation screen to be displayed after the process in the step S43 is executed. After then, the flow returns to the step S43 through the step S42 to read the next macro operation from the first MFP.

In the meantime, if it is judged in the step S44 not to be able to execute the first operation, it is further judged whether or not to be able to shift or change the current operation screen to another operation screen (step S46). If it is judged to be able to shift the current operation screen to another operation screen, the operation screen to be referred is changed to another operation screen (step S47). Then, the macro process for changing the operation screen to another operation screen is added to the transmission macro (step S48). After then, the flow again returns to the step S44 to judge whether or not to be able to execute the macro operation on the current operation screen of the second MFP.

In the meantime, if it is judged in the step S46 not to be able to shift the current operation screen to another operation screen, it is considered that the macro generated in the first MFP cannot be used in the second MFP, and such a fact is output as an error to the screen or the like of the operation panel unit 1 (step S50). After then, the process ends. Incidentally, in the case where it is impossible to shift the operation screen to another operation screen and it is thus impossible to change the macro to the executable macro, the error is output in the step S50. However, the present embodiment is not limited to this. That is, the error may be output in a case where the image forming device to which the macro is transferred cannot execute the transferred macro.

In any case, after the processes in the steps S43 to S48 are repeated, if it is judged in the step S42 that the macro of the first MFP to be processed does not exist any more, the first MFP transmits or sends the generated transmission macros to the second MFP (step S49), and the process ends.

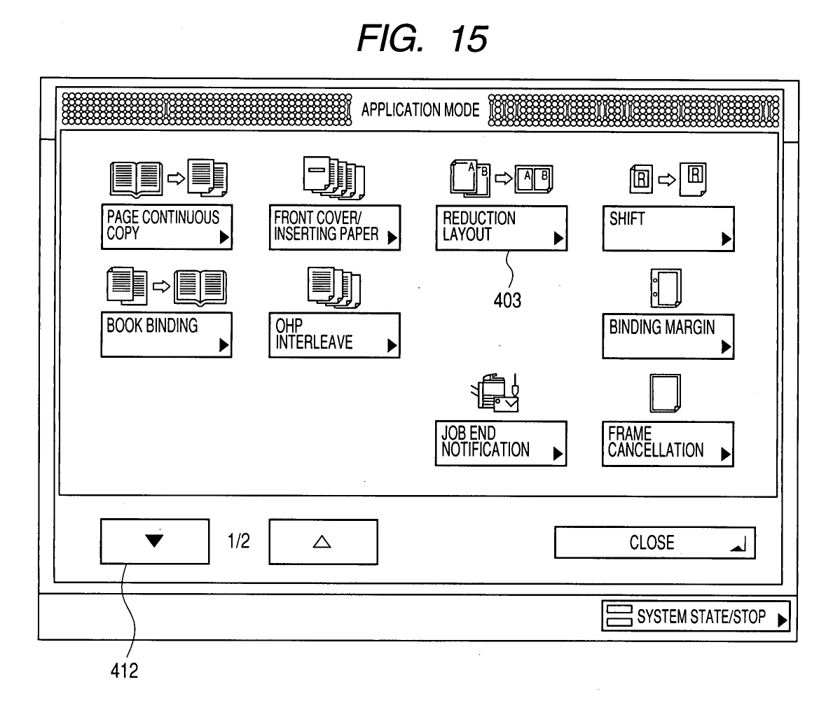

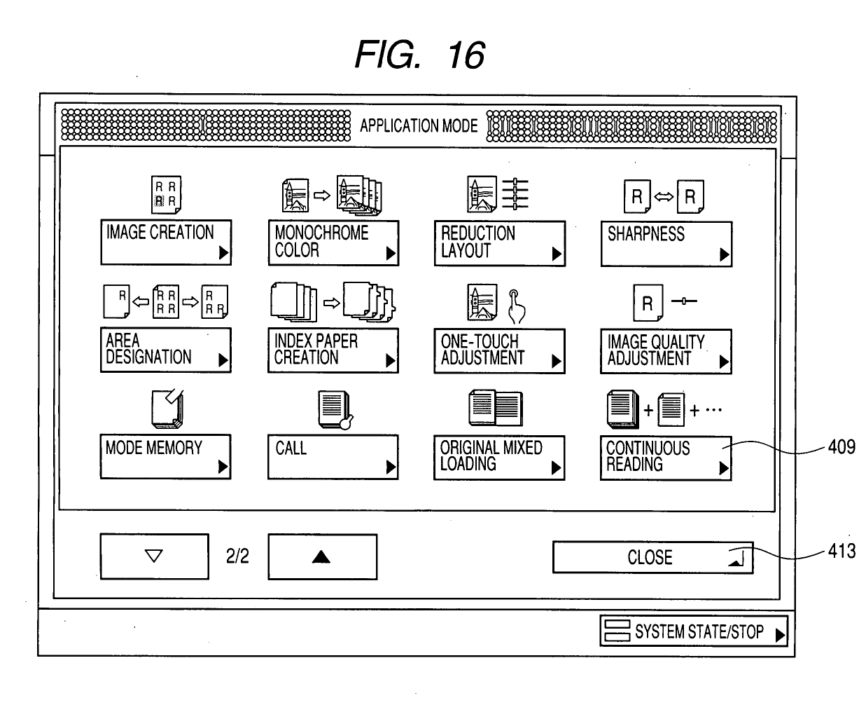

More specifically, the case of transmitting the macro (FIG. 13) generated by the first MFP to the second MFP will be explained. In the present embodiment, the button displaying state of the second MFP is different from that on the first MFP. That is, unlike the first MFP, the reduction layout button and the continuous reading button are displayed respectively on the different screens. FIG. 15 is a diagram showing the operation screen on which the reduction layout button is arranged, and FIG. 16 is a diagram showing the operation screen on which the continuous reading button is arranged.

Initially, in the step S41, the first MFP acquires the layer information of the operation screen to be displayed on the operation panel unit of the second MFP. Then, in the step S43, the first operation of the macro intended to be transmitted from the first MFP to the second MFP is acquired. That is, “DEPRESS BUTTON ID 312” of STEP1 shown in FIG. 13 (that is, to change the operation screen to that in the application mode) is acquired.

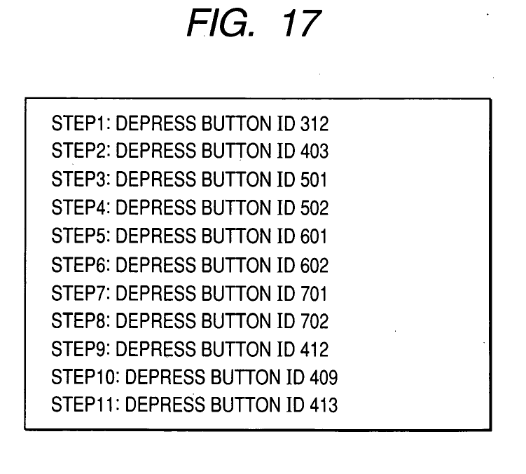

In the step S44, the first MFP judges whether or not the acquired macro “DEPRESS BUTTON ID 312” (to change the operation screen to that in the application mode) can be executed in the second MFP. In this case, since the application mode (button ID “312”) must be present on the initial screen of the second MFP, the first MFP generates in the step S45 the macro “DEPRESS BUTTON ID 312” as the transmission macro (FIG. 17). At that time, the screen to be referred in the second MFP is changed to the operation screen in the application mode.

After then, the flow again reruns to the step S43, whereby the first MFP selects the next macro “DEPRESS BUTTON ID 403” of STEP2 intended to be transmitted from the first MFP to the second MFP (FIG. 13). Likewise, since the respective macros in STEP2 to STEP8 can be all executed on the operation screen of the second MFP, the processes in the steps S43 to S45 are repeated to generate the transmission macro (see FIG. 17).

Next, the case where “DEPRESS BUTTON ID 409” of STEP9 shown in FIG. 13 is depressed will be explained. If “DEPRESS BUTTON ID 409” is selected in the step, S43, it is judged in the step S44 whether or not to be able to execute the macro in the second MFP. At that time, the operation screen of the second MFP is in the state shown in FIG. 15. That is, since the continuous reading button corresponding to the button ID “409” is not present on the screen shown in FIG. 15, the macro operation cannot be executed.

For this reason, it is judged in the step S46 whether or not to be able to shift the current operation screen (page) to another operation screen (page). Here, since the application mode shown in FIG. 15 consists of the plural pages, it is possible by depressing the next page button 412 to shift to the next page in the step S47. Thus, the screen is shifted or changed to the screen shown in FIG. 16, and the macro “DEPRESS BUTTON ID 412” is added to the transmission macro in the step S48 (see FIG. 17).

After then, the flow again returns to the step S44 to judge whether or not the macro, “DEPRESS BUTTON ID 409” acquired in the step S43 can be executed in the second MFP. Here, since the continuous reading button corresponding to the button ID “409” is present on the screen shown in FIG. 16, the macro operation can be executed. Thus, the macro “DEPRESS BUTTON ID 409” is added to the transmission macro in the step S45 (see FIG. 17).

Then, if the macro of STEP10 is acquired in the step S43 and added to the transmission macro in the steps S44 and S45, the macros shown in FIG. 13 are all acquired. Thus, it is judged in the step S42 that the macro of the first MFP to be processed does not exist any more, and, in the step S49, the first MFP transmits the macros generated as the transmission macro to the second MFP. FIG. 17 shows the transmission macro to be transmitted to the second MFP. As explained above, STEP9 in FIG. 17 corresponds to the macro which is added to be transmitted to the second MFP.

As above, according to the image forming device in the present embodiment, in the case where the macro generated in the first MFP is transmitted to the second MFP, the relevant macro is first changed and then output so as to be executable in the second MFP. Therefore, the generated macro can be used in many kinds of devices. Moreover, even if the menu layers, the button locations, the number of buttons and the like on the operation screen of one device are different from those on the operation screen of the other device, the contents of the macro are changed or modified so as to absorb these differences, and then the changed macro is actually transmitted, whereby it is possible to execute the same macro in the difference devices.

Incidentally, it should be noted that the present invention is not limited to the constitution described in the above embodiment. That is, the present invention is also applicable to any constitution if it can achieve the functions indicated in the appended claims or the functions described in the above embodiment.

For example, in the above embodiment, the transmission macro is generated in the first MFP, and then the generated macro is transmitted to the second MFP. However, the operation for generating the transmission macro can also be executed by the server device such as the database server 104 shown in FIG. 1, or the like.

In that case, the database server 104 executes the flow chart shown in FIG. 14. More specifically, the macro generated in the first MFP is received by the database server 104 through the LAN 19, and the received macro is transmitted to the second MFP. Then, if it is judged in the second MFP to execute the setting registration with respect to the received macro, the database server 104 starts the process according to the flow chart shown in FIG. 14. However, in the process of the step S41 in the relevant flow chart, the layer information of the operation unit of the first MFP is acquired in addition to the layer information of the operation unit of the second MFP (alternatively, both the layer information of the first MFP and the layer information of the second MFP are previously stored in the memory, and then read and acquired).

Moreover, after the macro of the first MFP was transmitted to the second MFP, the second MFP itself can change or modify the relevant macro so as to be able to execute it.

Here, in the case where the second MFP receives the macro from the first MFP, the second MFP acquires the layer information of the operation unit of the first MFP, and changes or modifies the received macro based on the acquired layer information so as to be able to execute it. Incidentally, the difference between the process by the first MFP and the process by the second MFP is equivalent to the difference between the process by the transmission side and the process by the reception side. In other words, the essential process in the first MFP is substantially the same as that in the second MFP.

In addition, it is needless to say that various methods can be adopted to achieve the same effect as above. More specifically, the layer information of the various devices is previously stored in the database server 104, whereby the first MFP can change or modify the macro by referring to the stored layer information of the second MFP and then transmit the changed macro. On the contrary, the second MFP can receive the macro from the first MFP, change or modify the received macro by referring to the layer information of the first MFP previously stored in the database server 104, and then register the changed macro.

Moreover, in the step S50 of FIG. 14, the error is output when the button by which the macro can be executed is not found. However, for example, an error can also be output when the function described in the macro is not present in the MFP at the transmission destination. In addition, an error may also be output when the macro ends while something setting is being executed.

In the above embodiment, the case where the macro is transmitted between the same types of MFP's. However, the macro can be also transmitted between the different types of MFP's if the correspondences of the button ID and the like are satisfied between them. In that case, even if the menu layers, the button locations, the number of buttons and the like on the operation screen of one device are different from those on the operation screen of the other device, the same macro can be executed.

Besides, in the present embodiment, the different button ID's are respectively allocated to all the buttons displayed on each screen of the operation panel unit. However, it is also possible to allocate the screen ID to each screen displayed on the operation panel unit so that the kind of button on the relevant screen can be discriminated in the form of “screen ID”+“button ID”. By doing so, it is possible to apply the same button ID respectively to the different screens. For example, the same button ID can be allocated respectively to the buttons for executing the same operation on the different screens.

Moreover, the present invention may be applied, in addition to the touch-panel operation screen, to the device of which the display screen is changed by handling the hard keys provided thereon, and to the device which uses the hard keys sequentially handled without displaying them.

Incidentally, the above embodiment is explained with respect to the MFP (copying machine). However, the present invention is not limited to this. That is, it is needless to say that the present invention is also applicable to another device (e.g., a scanner device, a facsimile machine, a printer device, a PC, or the like) on which the user executes the operation by using the operation panel.

Moreover, it is needless to say that the object of the present invention can be achieved by supplying a storage medium recording thereon the program codes of software to realize the functions of the above embodiment to a system or a device, and causing a computer (CPU, MPU, or the like) in the system or the device to read and execute the program codes stored in the storage medium. In this case, the program codes themselves read out of the storage medium realize the functions of the above embodiment. Therefore, the storage medium storing these the program codes constitutes the present invention.

As the storage medium from which the program codes are supplied, for example, a ROM, a floppy™ disk, a memory card such as a PCMCIA (Personal Computer Memory Card International Association) card, a CompactFlash™ card or the like, a hard disk, a micro DAT (digital audio tape), a magnetooptical disk, an optical disk such as a CD-R, a CD-RW or the like, a phase-change optical disk such as a DVD (digital versatile disk) or the like can be used. Moreover, the above program codes may be downloaded through the network.

Further, it is needless to say that the present invention includes not only a case where the functions of the above embodiment are realized by executing the program codes read by the computer, but also a case where an OS (operating system) or the like running on the computer executes a part or all of the actual process on the basis of the instructions of the program codes and thus the, functions of the above embodiment are realized by the relevant process.

Furthermore, it is needless to say that the present invention also includes a case where, after the program codes read out of the storage medium are written into a function expansion board inserted in the computer or a memory in a function expansion unit connected to the computer, a CPU or the like provided in the function expansion board or the function expansion unit executes a part or all of the actual process on the basis of the instructions of the program codes, and thus the functions of the above embodiment are realized by the relevant process.

This application claims priority from Japanese Patent Application No. 2004-231242 filed on Aug. 6, 2004, which is hereby incorporated by reference herein.

What is claimed is:

1. A data processing device which stores an operation procedure to be executed through an operation unit, and generates a macro for reproducing the stored operation procedure, comprising:
an information acquisition unit adapted to acquire information concerning an operation unit of another data processing device;
a change unit adapted to change, based on the acquired information concerning the operation unit of said another data processing device, the generated macro to a macro capable of being executed in the operation unit of said another data processing device; and
a transfer unit adapted to transfer the changed macro to said another data processing device.

2. A data processing device according to claim 1, further comprising a button generation unit adapted to generate a dedicated button for executing the macro, on a screen of the operation unit.

3. A data processing device according to claim 1, wherein the operation procedure includes information indicating a button selected through the operation unit and information indicating the operation procedure concerning the selected button.

4. A data processing device according to claim 1, wherein the operation procedure includes information indicating a screen displayed on the operation unit, information indicating a button within the displayed screen, and information indicating the operation procedure concerning the button.

5. A data processing device according to claim 1, wherein the transfer of the macro by said transfer unit and the acquisition of the information concerning the operation unit by said information acquisition unit are executed through a network.

6. A data processing device according to claim 1, further comprising a notification unit adapted to notify a user that, by said change unit, the generated macro cannot be changed to the macro capable of being executed in the operation unit of said another data processing device.

7. A data processing device according to claim 1, further comprising a notification unit adapted to notify a user that another image forming device located at a destination to which the macro is transferred cannot execute the macro.

8. An information processing device which is connected to a network together with plural data processing devices, comprising:
a macro acquisition unit adapted to acquire a macro, transferred from a first data processing device, for reproducing an operation procedure to be executed through an operation unit;
an information acquisition unit adapted to acquire information concerning operation units of said first data processing device and a second data processing device;
a change unit adapted to change, based on the information acquired by said information acquisition unit and concerning the operation unit, the acquired macro to a macro capable of being executed in the operation unit of said second data processing device; and
a transfer unit adapted to transfer the changed macro to said second data processing device.

9. A data processing device which stores an operation procedure to be executed through an operation unit, and generates a macro for reproducing the stored operation procedure, comprising:
an information acquisition unit adapted to acquire information concerning an operation unit of another data processing device;
a macro reception unit adapted to receive a macro generated by said another data processing device; and
a change unit adapted to change, based on the acquired information concerning the operation unit of said another data processing device, the received macro to a macro capable of being executed by said data processing device.

10. A data processing device according to claim 9, further comprising a button generation unit adapted to generates a dedicated button for executing the macro, on a screen of the operation unit.

11. A data processing device according to claim 9, wherein the operation procedure includes information indicating a button selected through the operation unit and information indicating the operation procedure concerning the selected button.

12. A data processing device according to claim 9, wherein the operation procedure includes information indicating a screen displayed on the operation unit, information indicating a button within the displayed screen, and information indicating the operation procedure concerning the button.

13. A data processing device according to claim 9, wherein the acquisition of the information concerning the operation unit by said information acquisition unit and the reception of the macro by said macro reception unit are executed through a network.

14. A data processing device according to claim 9, further comprising a notification unit adapted to notify a user that, by said change unit, the generated macro cannot be changed to the macro capable of being executed by said data processing device.

15. A data processing method which stores in a memory an operation procedure to be executed through an operation unit of a first data processing device, generates a macro for reproducing the stored operation procedure, and sets the generated macro in an operation unit of a second data processing device, said method comprising:
an information acquisition step of acquiring information concerning the operation unit of the second data processing device;
a change step of changing, based on the acquired information concerning the operation unit of the second data processing device, the generated macro to a macro capable of being executed by the operation unit of the second data processing device; and
a transfer step of transferring the changed macro to the second data processing device.

16. A data processing method which stores in a memory an operation procedure to be executed through an operation unit of a first data processing device, generates a macro for reproducing the stored operation procedure, and sets the generated macro in an operation unit of a second data processing device, said method comprising:
an information acquisition step of acquiring information concerning the operation unit of the first data processing device;
a macro reception step of receiving the macro generated by the first data processing device; and
a change step of changing, based on the acquired information concerning the operation unit of the first data processing device, the received macro to a macro capable of being executed by the second data processing device; and
a transfer step of transferring the changed macro to the second data processing device.

17. A control program which comprises computer-readable program codes for achieving a data processing method which stores in a memory an operation procedure to be executed through an operation unit of a first data processing device, generates a macro for reproducing the stored operation procedure, and sets the generated macro in an operation unit of a second data processing device, said method comprising:
an information acquisition step of acquiring information concerning the operation unit of the second data processing device;
a change step of changing, based on the acquired information concerning the operation unit of the second data processing device, the generated macro to a macro capable of being executed by the operation unit of the second data processing device; and
a transfer step of transferring the changed macro to the second data processing device.

18. A control program which comprises computer-readable program codes for achieving a data processing method which stores in a memory an operation procedure to be executed through an operation unit of a first data processing device, generates a macro for reproducing the stored operation procedure, and sets the generated macro in an operation unit of a second data processing device, said method comprising:
an information acquisition step of acquiring information concerning the operation unit of the first data processing device;
a macro reception step of receiving the macro generated by the first data processing device; and
a change step of changing, based on the acquired information concerning the operation unit of the first data processing device, the received macro to a macro capable of being executed by the second data processing device; and
a transfer step of transferring the changed macro to the second data processing device.

19. A storage medium which stores a control program comprising computer-readable program codes for achieving a data processing method which stores in a memory an operation procedure to be executed through an operation unit of a first data processing device, generates a macro for reproducing the stored operation procedure, and sets the generated macro in an operation unit of a second data processing device, said method comprising:
an information acquisition step of acquiring information concerning the operation unit of the second data processing device;
a change step of changing, based on the acquired information concerning the operation unit of the second data processing device, the generated macro to a macro capable of being executed by the operation unit of the second data processing device; and
a transfer step of transferring the changed macro to the second data processing device.

20. A storage medium which stores a control program comprising computer-readable program codes for achieving a data processing method which stores in a memory an operation procedure to be executed through an operation unit of a first data processing device, generates a macro for reproducing the stored operation procedure, and sets the generated macro in an operation unit of a second data processing device, said method comprising:
an information acquisition step of acquiring information concerning the operation unit of the first data processing device;
a macro reception step of receiving the macro generated by the first data processing device; and
a change step of changing, based on the acquired information concerning the operation unit of the first data processing device, the received macro to a macro capable of being executed by the second data processing device; and
a transfer step of transferring the changed macro to the second data processing device.
